(19) United States
(12) Patent Application Publication
(10) Pub. No.: US 2017/0022347 A1
(43) Pub. Date: Jan. 26, 2017

(54) Thermal Stability of FFKM Compounds

(71) Applicant: E I DU PONT DE NEMOURS AND COMPANY, Wilmington, DE (US)

(72) Inventors: Amiya Ratan Tripathy, Garnet Valley, PA (US); Christopher J. Bish, Kennett Square, PA (US)

(73) Assignee: E I DU PONT DE NEMOURS AND COMPANY, Wilmington, DE (US)

(21) Appl. No.: 14/804,375

(22) Filed: Jul. 21, 2015

(51) Int. Cl. C08K 3/30; C08K 3/36; C08K 3/04

(52) U.S. Cl. CPC C08K 3/30; C08K 3/04; C08K 3/36; C08K 2003/3036

(57) ABSTRACT

Compounds comprising a fluoroelastomer cured with peroxide curing agents and a metal sulfide, wherein the compounds comprise copolymerized units of unsaturated fluorinated olefins, a perfluoro(vinyl ether), and a cure site fluorinated monomer comprising one or more bromine atoms and/or one or more iodine atoms. Articles cured from these compounds; and processes of curing these compounds to result in articles.

### OVERVIEW

Described herein are compounds (also called curable compositions), and expressly including compounds comprising a perfluoroelastomer, which comprise metal sulfides, peroxide curing agents. Also described herein are articles cured from these compounds.

Elastomer compounds that comprise a fluoroelastomer have achieved outstanding commercial success because they can be used in severe environments, in particular, during exposure to high temperatures and to aggressive chemicals. For example, these compounds are used in seals in hot or otherwise sections of aircraft engines, in oil-well drilling devices, and as sealing elements in industrial equipment that operate at high temperatures.

The properties of cured elastomer compounds arise largely because of the stability and inertness of the copolymerized fluorinated monomers that make up the major portion of the polymeric backbone of these compounds. Such monomers include tetrafluoroethylene and perfluoro(alkyl vinyl) ethers. In order to develop elastomeric properties fully, fluoroelastomers are typically crosslinked, i.e., vulcanized or cured. To this end, a small percentage of cure site monomer is copolymerized with the monomers. Upon crosslinking, the cure site monomers reacts with a curing agent to form a crosslinked elastomer entity in the form of an article.

Cure site monomers described herein comprise one or more bromine atoms, one or more iodine atoms, or a nitrile group. Fluoroelastomers comprising cure site monomers may be cured by peroxide curing agents.

Cure site monomers comprising halogen atoms have been successfully incorporated into fluoroelastomers and the fluoroelastomer crosslinked by peroxide curing agents. U.S. Pat. No. 7,138,470 discloses the use of halogen containing cure site monomers in fluoroelastomers and the vulcanization of the fluoroelastomer using peroxide curing agents.

U.S. Pat. Application No. 2010/0286329 discloses iodine containing amorphous fluoropolymers which may be cured using peroxide curing agents.

Described herein are compounds that comprise metal sulfides, peroxide curing agents, and fluoroelastomers comprising cure site monomers, as well as articles comprising these compounds, which surprisingly exhibit improved compression set.

### DETAILED DESCRIPTION OF THE INVENTION

### Abbreviations

The claims and description herein are to be interpreted using the abbreviations and definitions set forth below:

“h”, “hrs” refers to hours.
“%” refers to the term percent.
“mole %” refers to mole percent.
“wt %” refers to weight percent.
“parts” refers to parts by weight.
“phr” refers to parts per hundred parts of fluoroelastomer (rubber); one of skill in the art uses and recognizes this term of measurement. For example, 3 parts of a component per 100 parts fluoroelastomer is written as 3 phr. In the compounds, processes, and articles described herein, phr is based on 100 parts of fluoroelastomer A.
“Ph” refers to a phenyl ring.
“ZnS” refers to zinc sulfide.

### DEFINITIONS

As used herein, the article “a” refers to one as well as more than one and does not necessarily limit its referent noun to the grammatical category of singular number.

As used herein, the terms “about” and “at or about”, when used to modify an amount or value, refers to an approximation of an amount or value that is more or less than the precise amount or value recited in the claims or described herein. The precise value of the approximation is determined by what one of skill in the art would recognize as an appropriate approximation to the precise value. As used herein, the term conveys that similar values, not precisely recited in the claims or described herein, can bring about results or effects that are equivalent to those recited in the claims or described herein, for which one of skill in the art would acknowledge as acceptably brought about by the similar values.

As used herein, the term “article” refers to an unfinished or finished item, thing, object, or an element or feature of an unfinished or finished item, thing or object. As used herein, when an article is unfinished, the term “article” may refer to any item, thing, object, element, device, etc. that has a form, shape, configuration that may undergo further processing, including further curing, in order to become a finished article. When an article is unfinished, the term “preform” may refer to that form, shape, configuration, any part of which may undergo further processing to become finished.

As used herein, when an article is finished, the term “article” refers to an item, thing, object, element, device, etc. that is in a form, shape, configuration that is suitable for a particular use/purpose without further processing of the entire entity or a portion of it.

An article may comprise one or more element(s) or subassembly(ies) that either are partially finished and awaiting further processing or assembly with other elements/subassemblies that together will comprise a finished article. In addition, as used herein, the term “article” may refer to a system or configuration of articles.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present). As used herein, the terms “comprises,” “comprising,” “includes,” “including,” “has,” “having”, “consisting essentially of”, and “consisting of” or any other variation of these, may refer either to a non-exclusive inclusion or to an exclusive inclusion.

When these terms refer to a non-exclusive inclusion, a process, method, article, or apparatus that comprises a list of elements is not limited to the listed elements but may include other elements not expressly listed or which may be inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present).

When these terms refer to a more exclusive inclusion, these terms limit the scope of a claim to those recited materials or steps that materially affect the novel elements of the recited invention.

When these terms refer to a wholly exclusive inclusion, these terms exclude any element, step or component not expressly recited in the claim.

As used herein, terms that describe molecules or polymers follow the terminology in the IUPAC Compendium of Chemical Terminology version 2.15 (International Union of Pure and Applied Chemistry) of Sep. 7, 2009.

As used herein, the term “unsaturated fluorinated olefin” refers to linear, branched, or cyclic hydrocarbon structures which comprise at least one unsaturated double bond and comprise at least one fluorine atom.

As used herein, the term “alkoxy” or “alkoxyl” refers to alkyl groups attached to an oxygen atom by a single bond. The other bond of the oxygen atom is connected to a carbon atom. Examples include methoxy, ethoxy, propoxy, isopropoxy, cyclopropyloxy, and cyclohexyloxy.

As used herein, the term “alkyl” includes linear, branched, or cyclic hydrocarbon structures and combinations of these. Alkyl does not include aromatic structures. Examples of linear alkyl groups include methyl, ethyl, propyl, butyl, pentyl, and hexyl groups. Branched alkyl groups include for example s- and t-butyl, and isopropyl groups. Examples of cyclic hydrocarbon groups include cyclopropyl, cyclopentyl, cyclohexyl, cyclobutyl, and cyclooctyl groups. Examples include methoxy, ethoxy, propoxy, isopropoxy, cyclopropyloxy, and cyclohexyloxy.

As used herein, the term “compound” refers to a composition that is able to be cured, i.e., a curable composition, as well as to a mixture of chemical entities that comprises at least a fluoroelastomer and a curing agent. The mixture of chemical entities has not been cured nor has undergone processing conditions that would cause the curing of the mixture of chemical entities to undergo curing.

As used herein, the prefix term “fluoro”, when placed as a prefix before a chemical entity name, refers to a chemical entity that has at least one fluorine atom as exemplified by the following designations: fluoroelastomers, perfluoroelastomers, fluorovinyl, and perfluorovinyl ethers. The prefix “fluoro”, when placed as a prefix before a chemical entity name, expressly includes “perfluoro” chemical entities. Thus, the prefix “fluoro”, when preceding a chemical entity name, indicates both “fluoro-” entities and “perfluoro-” entities.

As used herein, the term “cured” refers to that resultant entity that comprised a fluoroelastomer and which has been exposed to those conditions that caused the fluoroelastomer molecules to form sufficient crosslinks among themselves (that is, curing conditions) such that the resultant entity takes on a form or shape or configuration or structure that cannot be reprocessed, molded, or extruded into a different one. That is, once a resultant entity which comprised a fluoroelastomer has been exposed to curing conditions to thereby be cured, that entity cannot be re-cured to take on a substantially different form or shape or configuration or structure.

As used herein, the terms “curing”, “cured” refer to that processing of a compound comprising a fluoroelastomer, also called herein curable composition, which results in an entity taking on a form or shape or configuration or structure that cannot be reprocessed, molded, or extruded into a different one. Such processing refers to the “curing process/processing”, which requires the compound to be exposed to certain conditions in order to initiate the curing process, such conditions called curing conditions.

The resultant entity of the curing process is a “cured” entity, that is, an article as defined hereinabove. To be clear, curing results in the compound taking on a form or shape or configuration or structure of an article. Cured articles of compounds comprising a fluoroelastomer include, but are not limited to, O-rings, seals, and gaskets.

The terms “curing”, “cured” also expressly include differing degrees of processing of a compound such that the resultant entity takes on a form or shape or configuration or structure that cannot be reprocessed, molded, or extruded into a different one and which may exhibit certain physical properties as a result of the curing.

To the point, a compound may be initially cured to achieve a non-reprocessable form, shape, etc., which has been termed “cured” herein. The cured compound may be further subjected to additional curing conditions, which provide additional, subsequent curing. Such additional curing conditions may be variously termed herein either as “curing” or as “post-curing”. That is, the terms “curing”, “cured” refer to both an initial curing process that results in a first cured, resultant entity and also expressly refer to any subsequent curing process that results in a subsequently cured, resultant entity that may or not possess different material or physical properties than those of the first cured, resultant entity.

### Ranges and Preferred Variants

Any range set forth herein expressly includes its endpoints unless explicitly stated otherwise. Setting forth an amount, concentration, or other value or parameter as a range specifically discloses all possible ranges formed from any possible upper range limit and any possible lower range limit, regardless of whether such pairs of upper and lower range limits are expressly disclosed herein. The compounds, processes and articles described herein are not limited to specific values disclosed in defining a range in the description.

The disclosure herein of any variation in terms of materials, methods, steps, values, and/or ranges, etc.—whether identified as preferred or not—of the processes, compounds and articles described herein specifically intends to include any possible combination of materials, methods, steps, values, ranges, etc. For the purpose of providing photographic and sufficient support for the claims, any disclosed combination is a preferred variant of the processes, compounds, and articles described herein.

In this description, if there are nomenclature errors or typographical errors regarding the chemical name any chemical species described herein, including co-agents of formula (IX), the chemical structure takes precedence over the chemical name. And, if there are errors in the chemical structures of any chemical species described herein, the chemical structure of the chemical species that one of skill in the art understands the description to intend prevails.

### Generally

Described herein are compounds as defined herein and which expressly include compounds comprising a perfluoroelastomer, and articles prepared by curing the compounds described herein. Also described herein are processes for curing the compounds described herein.

More specifically, the compounds described herein comprise:

A. a fluoroelastomer comprising copolymerized units of:
(1) one or more copolymerized unsaturated fluorinated olefins;
(2) at least one fluorovinyl ether selected from the group consisting of perfluoro(alkyl vinyl) ethers, perfluoro(alkoxy vinyl) ethers, fluoro(alkyl vinyl) ethers, fluoro(alkoxy vinyl) ethers, and mixtures of these;
(3) one or more cure site fluorinated monomers;
B. a metal sulfide of formula (I):

M-S (I)

M being selected from Zn, Mg, Ca, Mn, Fe, and Cu;
C. a peroxide curing agent;
D. 0.5 to 100 parts per hundred parts fluoroelastomer of carbon black;
E. 0.5 to 25 parts per hundred parts fluoroelastomer of one or more fillers selected from the group consisting of nonperfluoro fluorine-containing elastomers, micropowders, anhydrous silica, acidic silica, and fumed silica; and
F. 0.01 to 10 parts per hundred parts fluoroelastomer of at least one co-agent;
wherein, when the compound has been cured:
the compression set of the cured compound, as measured at 168 hours according to method ASTM D395, ranges between 4% and 20% greater than the compression set, as measured for the same duration and by the same method, of an identical cured compound lacking element B.

The processes described herein comprising the step of curing a compound that comprises:

A. a fluoroelastomer comprising copolymerized units of:
(1) one or more copolymerized unsaturated fluorinated olefins;
(2) a fluorovinyl ether selected from the group consisting of perfluoro(alkyl vinyl) ethers, perfluoro(alkoxy vinyl) ethers, fluoro(alkyl vinyl) ethers, fluoro(alkoxy vinyl) ethers, and mixtures of these; and
(3) one or more cure site fluorinated monomers;
B. a metal sulfide of formula (I):

M-S (I),

M being selected from Zn, Mg, Ca, Mn, Fe, and Cu;
C. a peroxide curing agent;
D. 0 to 100 parts per hundred parts fluoroelastomer of carbon black;
E. 0 to 25 parts per hundred parts fluoroelastomer of one or more fillers selected from the group consisting of nonperfluoro fluorine-containing elastomers, micropowders, anhydrous silica, acidic silica, and fumed silica; and
F. 0 to 10 parts per hundred parts fluoroelastomer;
to result in a cured compound,
wherein, when the compound has been cured:
the compression set of the cured compound, as measured in air at 168 hours according to method ASTM D395-89, ranges between 4% and 20% greater than the compression set, as measured for the same duration and by the same method, of an identical cured compound lacking element B.

Also described herein are articles that have been prepared by curing the compounds described herein.

Variations in the compounds, articles, and processes for curing compounds described herein may expressly include any of the following elements or any combination of the following elements. That is, it is expressly contemplated that the compounds, articles and processes described herein and recited in the claims may be varied to include the specific elements listed in this paragraph or any combination of these specific elements:

the unsaturated fluorinated olefin may be selected from the group consisting of tetrafluoroethylene, 1,1-difluoroethylene, and mixtures of these; and/or

the fluorovinyl ether may be selected from the group consisting of perfluoro(methyl vinyl) ether and perfluoro(propyl vinyl); and/or

the metal sulfide (B) is zinc sulfide; and/or

the cure site monomer may be nitrile-containing; and/or

the cure site monomer may comprise one or more bromine atoms, one or more iodine atoms, or mixtures of these; and/or

the carbon black is present from about 0.5 to 100 parts per hundred parts fluoroelastomer; and/or

the one or more fillers is present from about 0.5 to 25 parts per hundred parts fluoroelastomer; and/or

the filler is selected from the group consisting of nonperfluoro fluorine-containing elastomers, micropowders, titanium dioxide, metal silicates, metal phosphates, anhydrous silica, acidic silica, and fumed silica; and/or

the co-agent ranges from about 0.01 to 10 parts per hundred parts fluoroelastomer; and/or

the co-agent is selected from the group consisting of triallyl isocyanurate, trimethallyl isocyanurate, and dibromopropyl isocyanurate; and/or

an additive selected from stabilizers, plasticizers, lubricants, and processing aids may be included.

A) Fluoroelastomers

Fluoroelastomers A described herein may be fluorinated or perfluorinated and comprise at least the following three copolymerized monomer units: A (1) about 25 to about 74.9 mole percent of one or more unsaturated fluorinated olefins; A (2) about 10 to about 74.9 mole percent fluorovinyl ether monomers selected from the group consisting of perfluoro(alkyl vinyl) ethers, perfluoro(alkoxy vinyl) ethers, fluoro(alkyl vinyl) ethers, fluoro(alkoxy vinyl) ethers, and mixtures of these; and A (3) about 0.1 to 5 mole percent of a cure site monomer comprising one or more bromine atoms, one or more iodine atoms, a nitrile group, or a mixture of these, wherein the mole percent of each of A (1), (2), and (3) is based on the total mole percent of A (1), (2), and (3) in fluoroelastomer A.

Fluoroelastomers A described herein may contain any of a variety of end groups as a result of the use of varying initiators or chain transfer agents during polymerization. Non-limiting examples of end groups include sulfonate, sulfonic acid, carboxylate, carboxylic acid, carboxamide, difluoromethyl groups, trifluorovinyl groups, or perfluorinated alkyl groups

### A (1) Copolymerized Unsaturated Fluorinated Olefin

Copolymerized unsaturated fluorinated olefins A(1) includes fluorinated and perfluorinated olefins. Examples of fluorinated and perfluorinated olefins include tetrafluoroethylene (C2F4), hexafluoropropylene, 1,1-difluoroethylene, 1,1,2-trifluoroethylene, i-fluoroethylene, and mixtures of these. The concentration of unsaturated fluorinated olefin A(1) is about 25 and 74.9 mole percent of the total moles of monomer units in fluoroelastomer A.

### A (2) Fluorovinyl Ether Monomer

Fluorovinyl ether monomer A (2) includes, perfluoro(alkyl vinyl) ethers (PAVE), perfluoro(alkoxy vinyl) ethers, fluoro(alkyl vinyl) ethers, fluoro(alkoxy vinyl) ethers, and mixtures of these.

Suitable fluorovinyl ether monomers include those having any one of formula (II), (III), (IV), (V) or (VI) hereinbelow.

CF₂═CFO(R_{f′}O)ₙ(R_{f″}O)ₘR_{f} (II),

where R_{f′} and R_{f″} are linear or branched perfluoroalkylene groups of 2-6 carbon atoms, m and n are independently 0-10, and R_{f} is a perfluoroalkyl group of 1-6 carbon atoms.

CF₂═CFO(CF₂CFXO)ₙR_{f} (III),

where X is F or CF₃, n is 0-5, and R_{f} is a perfluoroalkyl group of 1-6 carbon atoms. Preferably, n is 0 or 1 and R_{f} contains 1-3 carbon atoms. Examples of such fluorovinyl ether monomers include perfluoro(methyl vinyl) ether and perfluoro(propyl vinyl) ether.

CF₂═CFO[(CF₂)ₘCF₂CFZO]ₙR_{f} (IV),

where R_{f} is a perfluoroalkyl group having 1-6 carbon atoms, m=0 or 1, n=0-5, and Z═F or CF₃.

CF₂═CFO[(CF₂CFCF₃O)ₙ(CF₂CF₂CF₂O)ₘ(CF₂)ₚ]CₓF_{2X+1} (V),

where m and n=1-10, p=0-3, and x=1-5 and includes monomers where n=m=0-1, and x=1.

CF₂═CFOCF₂CF(CF₃)O(CF₂O)ₘCₙF₂ₙ₊₁ (VI),

where n=1-5, m=1-3, and where, preferably, n=1.

Mixtures of perfluoro(alkyl vinyl) ethers, perfluoro(alkoxy vinyl) ethers, fluoro(alkyl vinyl) ethers, and fluoro(alkoxy vinyl) ethers may also be used.

The concentration of fluorovinyl ether monomers A(2) ranges from about 10 to 74.9 mole percent, preferably from 15 to 60 mole percent, of the total mole percent of A(1), (2), and (3) in fluoroelastomer A

### A (3) Cure Site Monomer

Fluoroelastomer (A) further comprises copolymerized units of one or more cure site fluorinated monomers A (3). Suitable cure site monomers include fluorinated olefins that include nitrile containing or which comprise one or more bromine atoms or one or more iodine atoms or mixtures of these.

Such fluorinated olefins include cure site monomers having formula (VII) or (VIII):

CR²R²═(CR³R⁴)ₙ—CR⁵R⁶ (VII)

where n=1-4; R¹, R², R³, R⁴, and R⁵═H or F wherein at least one of R¹ to R⁵ is F; and R⁶ is Br or I, preferably I;
or

CF₂═CF—O(CR⁷R⁸)ₙ—R⁹ (VIII)

where n=1-4; R⁷ and R⁸═H or F wherein at least one of R⁷ or R⁸ is F; and R⁹ is Br or I, preferably I;

Suitable cure site monomers may include nitrile-containing fluorinated olefins and nitrile-containing fluorinated vinyl ethers. Useful nitrile-containing cure site monomers include compounds of formulae (IX)-(XIII):

CF₂═CF—O(CF₂)ₙ—CN (IX),

where n=2-12, preferably 2-6;

CF₂═CF—O[CF₂—CFCF₃—O]ₙ—CFCF₃—CN (X),

where n=0-4, preferably 0-2;

CF₂═CF—[OCF₂CFCF₃])ₓ—O—(CF₂)ₙ—CN (XI),

where x=1-2, and n=1-4;
and

CF₂═CF—O—(CF₂)ₙ—O—CF(CF₃)CN (XII),

where n=2-4.

When a cure site monomer comprising a nitrile group is used, compounds of formula (XI) are preferred. Especially preferred cure site monomers comprising a nitrile group include perfluorinated polyethers having a nitrile group and a trifluorovinyl ether group. A most preferred cure site monomer is perfluoro(8-cyano-5-methyl-3,6-dioxa-1-octene) (8-CNVE) and represented by formula (XIII):

CF₂═CFOCF₂CF(CF₃)OCF₂CF₂CN (XIII)

Fluoroelastomer A may comprise any of a variety of end groups as a result of the use of varying initiators or chain transfer agents during polymerization. Non-limiting examples of end groups include sulfonate, sulfonic acid, carboxylate, carboxylic acid, carboxamide, difluoromethyl groups, trifluorovinyl groups, or perfluorinated alkyl groups.

Cure site monomers in the compounds described herein range from about 0.1 to about 10 mole percent, preferably from 0.3 to 7 mole percent, and more preferably from 0.3 to 2 mole percent of the total moles of polymerizable monomer units in fluoroelastomer A.

### B) Metal Sulfide

The metal sulfide in the compounds described herein is defined by formula (I):

M-S (I), where

M is selected from Zn, Mg, Ca, Mn, Fe, Cu, and is used with a peroxide curing agent. The concentration of metal sulfide (B) used to prepare compounds described herein generally ranges from about 0.1 to 20 phr, preferably from 1 to 20 phr, more preferably from 5 to 20 phr.

### C) Peroxide Curing Agent

Peroxide curing agents for the compounds described herein include organic peroxides. Preferred organic peroxides, are those that do not decompose during dynamic mixing temperatures to prepare the compounds comprising a fluoroelastomer but which generate peroxide radicals under curing conditions. Examples of non-limiting organic peroxides include dicumyl peroxide; 2,5-dimethyl-2,5-di(t-butylperoxy)hexane; di-t-butyl peroxide; t-butylperoxy benzoate; 2,5-dimethyl-2,5-di(t-butylperoxy)hexane-3; lauryl peroxide; 1,1-bis(t-butylperoxy)-3,5,5-trimethylcyclohexane; 1,1-bis(t-butylperoxy)cyclohexane; 2,2-bis(t-butylperoxy)octane; n-butyl-4,4-bis(t-butylperoxy)valerate; 2,2-bis(t-butylperoxy)butane; 2,5-dimethylhexane-2,5-dihydroxyperoxide; di-t-butyl peroxide; t-butylcumyl peroxide; α, α″-bis(t-butylperoxy-m-isopropyl)benzene; benzoyl peroxide, t-butylperoxybenzene; 2,5-dimethyi-2,5-di(benzoylperoxy)-hexane; t-butylperoxymaleic acid; and t-butylperoxyisopropylcarbonate.

The concentration of peroxide curing agent used generally will be from about 0.1 to 10 phr, preferably 1 to 5 phr, and more preferably from 1 to 3 phr.

### D) Carbon Black

Carbon black is known to balance modulus, tensile strength, elongation, hardness, abrasion resistance, conductivity, and processability of polymer compositions. In the compounds described herein, small particle size, high surface area carbon blacks are preferred, such as SAF carbon black, a highly reinforcing black with typical average particle size of about 14 nm and designated N 110 in Group No. 1, according to ASTM D 1765. Specifically, U.S. Pat. No. 5,554,680 describes a particular class of carbon blacks. that have average particle sizes of at least about 100 nm to about 500 nm as determined by ASTM D 3849. Examples include MT blacks (medium thermal black) designated N-991, N-990, N-908, and N-907, and large particle size furnace blacks, of which MT blacks are preferred.

When carbon black is present, its amount may range from 1 to 100 phr, preferably from 2 to 60 phr, and more preferably from 5 to 60 phr.

### E) Fillers

In addition to, or in combination with carbon black, the compounds described herein may include fillers, such as anhydrous silica and in particular, acidic silica or fumed silica. Such silicas are available from Degussa AG (Frankfurt, Germany) as Aerosil®, of which a preferred is Aerosil® 200. Other suitable silicas include Reolosil® silicas from Tokuyama KK (Tokyo, Japan), for example Reolosil® Q513, Reolosil® QS102, and Reolosil® QS30.

Silica amounts may range from 1 to 25 phr, preferably from 1 to 7 phr.

Additional fillers in these compounds include micropowders, typically partially crystalline polymers. Micropowders include finely divided, easily dispersed plastic fluoropolymers that are solid at the highest temperature utilized in fabrication and curing of the compounds described herein. As used here, Solid refers to the fact that the plastic fluoropolymer has a crystalline melting temperature above the processing temperature(s) of the compounds described herein. Suitable micropowders in these compounds include, but are not limited to, those based on tetrafluoroethylene (TFE) polymers, which includes polytetrafluoroethylene (PTFE) and copolymers of TFE with small concentrations of about 1 mole percent or less of at least one copolymerizable modifying monomer such that the micropowders do not melt during processing of the fluoroelastomer A comprising the micropowder(s). The modifying monomer may be, for example, hexafluoropropylene (HFP), perfluoro(propyl vinyl) ether (PPVE), perfluorobutyl ethylene, chlorotrifluoroethylene, or another monomer that introduces side groups into the polymer molecule.

Tetrafluoroethylene polymers used as fillers in the compounds described herein include copolymers of TFE having sufficient concentrations of copolymerized units of one or more monomers to reduce the melting point below that of PTFE. Such copolymers generally have melt viscosity in the range of 0.5-60×10³ Pa·s, but viscosities outside this range are also known.

Perfluoroolefins and perfluoro(alkyl vinyl) ethers are preferred comonomers; hexafluoropropylene and perfluoro(propyl vinyl) ether are most preferred. Melt-fabricable tetrafluoroethylene copolymers such as tetrafluoroethylene/hexafluoropropylene copolymer and tetrafluoroethylene/perfluoro(propyl vinyl)ether copolymer may be used, provided they satisfy constraints on melting temperature with respect to the processing temperature of fluoroelastomer A. These copolymers may be in powder form. Examples of TFE copolymers include TFE/hexafluoropropylene copolymer and TFE/perfluoro(propyl vinyl)ether copolymers.

The compounds described herein may include additional fillers, identified herein as one or more non-perfluoro elastomers that can independently cross-link with any crosslinkable group in these compounds. Examples of these non-perfluoro elastomers have at either its main chain or an end of its side chain one or more crosslinkable group selected from the group consisting of cyano (—CN); carboxyl (—COOH); alkoxycarbonyl (—COOR₉, where R₉ is a monovalent organic group); and an acid halide group (—COX₁, where X₁ is a halogen atom) capable of a crosslinking reaction with any crosslinkable group in the compounds described herein. Examples of non-perfluoro-elastomers include, but are not limited to, a fluorine-containing rubber, a thermoplastic fluorine-containing rubber, and a rubber composition comprising a fluorine-containing rubber.

The fluorine-containing rubber may contain a monomer unit independently selected from the group consisting of vinylidene fluoride (VDF), tetrafluoroethylene, and hexafluoropropylene, and at least one additional monomer such as tetrafluoroethylene, hexafluoropropylene, perfluoro(alkyl vinyl ether), chlorotrifluoroethylene, trifluoroethylene, trifluoropropylene, pentafluoropropylene, trifluorobutene, tetrafluoroisobutene, vinyl fluoride, and iodine-containing fluorinated vinyl ether, ethylene, propylene, alkyl vinyl ether, and combinations of these.

The concentration of filler in the compounds described herein ranges from about 0.01 to 100 phr, preferably from at least about 1 to 50 phr.

### F) Optional Co-Agent

The compounds described herein may include one or more optional co-agents, which include, but are not limited to, dibromopropyl isocyanurate, tri(methyl)allyl isocyanurate (TMAIC), triallyl isocyanurate (TAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(dial-lylamine)-s-triazine, triallyl phosphite, 1,2-polybutadiene, ethyleneglycol diacrylate, and diethyleneglycol diacrylate. Other co-agents may have the formula (XIV):

CH2=CH—R⁴—CH═CH2 (XIV),

wherein R⁴ may be a perfluoro alkylene of 1 to 8 carbon atoms.

The concentration of one or more co-agents, when included, ranges from about 0.1 to 10 phr, preferably 0.5 to 5 phr.

### Additives

The compounds described herein may include one or more additives, such as stabilizers, plasticizers, lubricants, and processing aids, which are typically utilized in fluoroelastomer compounding, when these retain adequate stability for the intended use. In particular, perfluoropolyethers can enhance low temperature performance.

The concentration of additives in these compounds ranges from 0.01 to 100 phr, preferably at least about 1 to 30 phr, and more preferably from about 5 to 30 phr.

Preparing Compounds Described Herein and Curing Articles Described Herein that Comprised these Compounds

The compounds described herein may be prepared by mixing until homogeneous fluoroelastomer A, metal sulfide (B), peroxide curing agent (C), and the other components carbon black, filler(s), additives, and co-agents, when present, using rubber compounding procedures such as a two roll rubber mill, an internal mixer, for example, a Banbury internal mixer, or in an extruder.

The compounds described herein may be cured by the application of heat and/or of pressure sufficient to cause the peroxide curing agent(s) to form crosslinks with cure site monomer(s). A dual cure system may also be used to cure the compounds. When compression molding is used to cure, a press cure cycle is preferably followed by a post cure cycle during which the press cured compound is heated at elevated temperatures in excess of 300° C. for several hours. The compounds described herein, when cured, become articles described herein and exhibit useful and suitable thermal stability and chemical resistance for the applications in which these articles are used. These articles are particularly useful as seals and gaskets for high temperature applications and in a broad range of chemical environments, and in seals for high temperature automotive uses, and as O-rings.

### Use of Metal Sulfides

The compounds described herein may be cured into articles such as O-rings and seals. It is believed that the addition of metal sulfide of formula (I) either alone or particularly in combination with a peroxide curing agent, and one or more filler(s), such as a fumed silica, as well as with curing co-agent(s), and additives to cure the compounds described herein, results in articles described herein (also known as cured compounds) that have a compression set improvement that ranges between 4 percent and 20 percent when compared to the compression set of an identical composition lacking the metal sulfide of formula (I). The compression set improvement of articles described herein may range between 5 percent and 20 percent, or between 4 percent and 15 percent, or between 5 percent and 15 percent, or between 4 percent and 13 percent.

### Examples

The exemplary compounds identified by “E” in the tables below are intended only to further illuminate and not to limit the scope of compounds, processes, and articles described and recited herein. Comparative examples are identified in the tables below by “C”.

### Materials

In the compounds, processes, and articles exemplified in the tables below, the following materials were used:

### FP-A:

a perfluoroelastomer prepared by the process disclosed in U.S. U.S. Pat. No. 6,646,077, cols. 9 to 10.
Perfluoro(methyl vinyl) ether:
available from E.I. DuPont de Nemours and Company, Wilmington, Del., USA [“DuPont”].

### Titanium Dioxide (TiO2):

Ti-Pure Rioi, available from The Chemours Company, Wilmington, Del., USA [“Chemours”].

### NPE:

a non-perfluoro elastomer, available as Zonyl® TE3950 from Chemours.

### Co-Agent:

a triallyl isocyanurate in a silicon-dioxide carrier, available as TAIC DLC®-A 72% from Harwick Standard Distribution Corporation, Akron, Ohio, USA.

### Peroxide:

2,5-Dimethyl-2,5-di(t-butylperoxy) hexyne-3/calcium carbonate/amorphous silica mixture, available as VAROX 130-XL from Vanderbilt Chemicals, LLC, Norwalk, Conn.

### Processing Aid:

a blend of fatty acid derivatives and waxes, available as STRUKTOL HT-290 from Strucktol Company of America, Stow, Ohio, USA.

### Filler A:

a fumed silica, available as AEROSIL® 200VS from Evonik Corporation, Piscataway, N.J., USA.

### Carbon Black 1:

a carbon black pigment, available as Thermax® Ultra Pure N908 from Cancarb Limited, Alberta, Canada [“Cancarb”].

### Carbon Black 2:

a thermal carbon black filler having an average particle size of 280 nm, available as Thermax® N990 from Cancarb.

### ZnS:

zinc sulfide, available as Sachtolith HD-S from Sachtleben Chemie GmbH, Germany.

### Methods

In the compounds, processes, and articles exemplified in the tables below, the following methods were used:

### Specific Process for Preparing Articles Described Herein

The following specific process may be used to prepare articles described herein from compounds described herein: A sheet of compound was extruded on a roll mill to a thickness of about 2 mm. One inch diameter circular washers were punched out of the extruded sheet. If the one inch circular washer weighs less than 2.5 g, the sheet is re-extruded with a wider gap in the nip roll until a punched test sample is at least 2.5 g. Circular washer test samples of the compound were used to prepare O-rings by the following cure process.

Standard 214 O-rings (3 cm×0.34 cm) were compression molded from the circular washer test samples in an 8″×8″ PHI press using max. 35000 psi pressure at 165° C. for TC90 plus 5 minutes. The O-ring samples were further cured, i.e., post-cured, by ramping the temperature from room temperature to 260° C. over a period of 40 hrs. and holding at a temperature of 260° C. for 8 hours in a nitrogen purged oven. The oven was then turned off and the O-ring allowed to cool to 50° C. at which time the O-ring is removed from the oven and allowed to cool to room temperature prior to testing. The O-rings are used for compression set testing with the results shown in Tables 1 and 2.

### Determination of Compression Set

O-rings (3 cm×0.34 cm), prepared as described in the immediately preceding paragraphs, were compression tested at 200° C. for 70 and 168 hours in air in accordance with ASTM D395-89.

Tables 1 and 2 hereinbelow list the examples and comparative examples of the compounds described herein.

TABLE 1

| COM- | | | | | | |
|---|---|---|---|---|---|---|
| PONENTS | | | | | | |
| (PHR*) | C1 | E1 | C2 | C3 | E2 | C4 |
| FP-A | 100 | 100 | 100 | 100 | 100 | 100 |
| TiO2 | 7 | 5 | 7 | 7 | 7 | 5 |
| NPE | 15 | 15 | 20 | 20 | 20 | 20 |
| Co-agent | 4 | 4 | 4 | 4 | 4 | 4 |
| Peroxide | 1 | 1 | 1 | 1 | 1 | 1 |
| Processing aid | 0.3 | 0.3 | 0.3 | 0.3 | 0.3 | 0.3 |
| Filler-A | 7 | 5 | 7 | 5 | 5 | 2 |
| Carbon Black-1 | 7 | 7 | 5 | 5 | 5 | 0 |
| Carbon Black-2 | | | | | | 5 |
| ZnS | | 10 | | | 10 | |

PHYSICAL PROPERTIES

| | | | | | | |
|---|---|---|---|---|---|---|
| Compression | 31.43 | 27.62 | 32.04 | 33.33 | 29.52 | 26.26 |
| Set (70 H) | | | | | | |
| Compression | 45.71 | 40.95 | 48.57 | 47.06 | 43.81 | 44.44 |
| Set (168 H) | | | | | | |

*PHR IS PARTS PER HUNDRED PARTS FP-A

As can be seen from the data in Table 1, C1 does not contain ZnS and exhibits a compression set value of 31.43 percent. E1 is a compound similar to C1 except it contains ZnS and exhibits the improved compression set value of 27.62 relative to that of C1. E2 has the same composition as C3 except it contains ZnS and exhibits a compression set of 29.52 percent, compared with that of 33.33 percent for C3. The improvement in compression set of E2 vs. C3 is greater than 10 percent. C4 does not comprise ZnS and has a compression set value of 26.26 percent when measured after 70 hours testing. However, after 168 hour testing, the compression set value has deteriorated to 44.44 percent, which is inferior to that for both E1 and E2.

These results show that the compounds described herein, when cured with a combination of peroxide curing agent and ZnS and formed into O-rings, exhibit better high temperature compression set values when tested for 168 hours, compared to compression set values for an identical compound lacking a metal sulfide.

The materials shown in Table 2 were used to prepare O-rings from compounds by compounding the ingredients on a two-roll rubber mill and subsequently curing the compound into the shape of an O-ring.

TABLE 2

| COM- | | | | | | |
|---|---|---|---|---|---|---|
| PONENTS | | | | | | |
| (PHR*) | C5 | E3 | E4 | E5 | C6 | C7 |
| FP-A | 100 | 100 | 100 | 100 | 100 | 100 |
| TiO2 | 5 | 7 | 2 | 5 | 7 | 7 |
| NPE | 15 | 10 | 15 | 15 | 20 | 20 |
| Co-agent | 4 | 4 | 4 | 4 | 4 | 4 |
| Peroxide | 1 | 1 | 1 | 1 | 1 | 1 |
| Processing aid | 0.3 | 0.3 | 0.3 | 0.3 | 0.3 | 0.3 |
| Filler-A | 5 | 3 | 3 | 5 | 5 | 5 |
| Carbon Black-1 | | | | | | |
| Carbon Black-2 | 7 | 2 | 2 | 2 | 5 | 5 |
| ZnS | | 10 | 15 | 10 | | |

PHYSICAL PROPERTIES

| | | | | | | |
|---|---|---|---|---|---|---|
| Compression | 28.28 | 24.51 | 26.47 | 26.98 | 30.30 | 33.33 |
| Set (70 H) | | | | | | |
| Compression | 44.12 | 38.24 | 38.24 | 38.24 | 44.44 | 47.06 |
| Set (168 H) | | | | | | |

*PHR IS PARTS PER HUNDRED PARTS FP-A

Table 2 shows that E3 to E5 each have superior compression set values compared to those for C5 to C7, which are similar in composition to E3 to E5 except for the ZnS. These results show that compounds, when cured with a combination of peroxide curing agent and ZnS into an article, exhibit superior high temperature compression set values when tested for 168 hours compared to an identical compound lacking a metal sulfide.

What is claimed is:

1. A compound comprising:
A. a fluoroelastomer comprising copolymerized units of:
(1) one or more unsaturated fluorinated olefins;
(2) a fluorovinyl ether selected from the group consisting of perfluoro(alkyl vinyl) ethers, perfluoro(alkoxy vinyl) ethers, fluoro(alkyl vinyl) ethers, fluoro(alkoxy vinyl) ethers, and mixtures of these; and
(3) one or more cure site fluorinated monomers,
B. 0.1 to 20 parts per hundred parts fluoroelastomer A of a metal sulfide of formula (I):
M-S (I)
M being selected from Zn, Mg, Ca, Mn, Fe, and Cu;
C. 0.1 to 10 parts per hundred parts fluoroelastomer A of a peroxide curing agent;
D. 0.5 to 100 parts per hundred parts fluoroelastomer A of carbon black;
E. 0.5 to 25 parts per hundred parts fluoroelastomer A of one or more fillers selected from the group consisting of nonperfluoro fluorine-containing elastomers, micropowders, anhydrous silica, acidic silica, and fumed silica; and
F. 0.01 to 10 parts per hundred parts fluoroelastomer A of at least one co-agent;
wherein, when the compound has been cured:
the compression set of the cured compound, as measured in air at 168 hours according to method ASTM D395-89, ranges between 4% and 20% greater than the compression set, as measured for the same duration and by the same method, of an identical cured compound lacking element B.

2. The compound of claim 1, wherein the cure site fluorinated monomer comprises at least one bromine or at least one iodine atom.

3. The compound of claim 1, wherein the compression set, as measured at 168 hours according to ASTM D395. ranges between 4% and 15% greater than the compression set, as measured for the same duration and by the same method, of an identical cured compound lacking element B.

4. A process comprising the step of curing a compound that comprises:
A. a fluoroelastomer comprising copolymerized units of:
(1) one or more unsaturated fluorinated olefins;
(2) a fluorovinyl ether selected from the group consisting of perfluoro(alkyl vinyl) ethers, perfluoro(alkoxy vinyl) ethers, fluoro(alkyl vinyl) ethers, fluoro(alkoxy vinyl) ethers, and mixtures of these; and
(3) one or more cure site fluorinated monomers comprising at least one bromine atom or at least one iodine atom;
B. 0.1 to 20 parts per hundred parts fluoroelastomer (A) of a metal sulfide of formula (I):
M-S (I),
M being selected from Zn, Mg, Ca, Mn, Fe, and Cu;
C. 0.1 to 10 parts per hundred parts fluoroelastomer A of a peroxide curing agent;
D. 0 to 100 parts per hundred parts fluoroelastomer of carbon black;
E. 0 to 25 parts per hundred parts fluoroelastomer of one or more fillers selected from the group consisting of nonperfluoro fluorine-containing elastomers, micropowders, anhydrous silica, acidic silica, and fumed silica; and
F. 0 to 10 parts per hundred parts fluoroelastomer,
to result in a cured compound,
wherein, when the compound has been cured:
the compression set of the cured compound, as measured in air at 168 hours according to method ASTM D395-89, ranges between 4% and 20% greater than the compression set, as measured for the same duration and by the same method, of an identical cured compound lacking element B.

5. The process of claim 4, wherein the unsaturated fluorinated olefin is selected from the group consisting of tetrafluoroethylene, 1,1-difluoroethylene, and mixtures of these.

6. The process of claim 4, wherein the fluorovinyl ether is selected from the group consisting of perfluoro(methyl vinyl) ether and perfluoro(propyl vinyl).

7. The process of claim 4, wherein the metal sulfide (B) is zinc sulfide.

8. The process of claim 4, wherein the carbon black is present from about 0.5 to 100 parts per hundred parts fluoroelastomer.

9. The process of claim 4, wherein the one or more fillers is present from about 0.5 to 25 parts per hundred parts fluoroelastomer.

10. The process of claim 9, wherein the filler is selected from the group consisting of nonperfluoro fluorine-containing elastomers, micropowders, Titanium dioxide, metal silicates, metal phosphates, anhydrous silica, acidic silica, and fumed silica.

11. The process of claim 4, wherein the co-agent ranges from about 0.01 to 10 parts per hundred parts fluoroelastomer.

12. The process of claim 11, wherein the co-agent is selected from the group consisting of triallyl isocyanurate, trimethallyl isocyanurate, and dibromopropyl isocyanurate.

13. The process of claim 4, wherein the compound further comprises an additive selected from stabilizers, plasticizers, lubricants, and processing aids.

14. The process of claim 4, wherein the compression set, as measured in air at 168 hours according to method ASTM D395-89, ranges between 4% and 15% greater than the compression set, as measured for the same duration and by the same method, of an identical cured compound lacking element B.

15. A process, comprising the step of curing a compound that comprises:
A. a fluoroelastomer comprising copolymerized units of:
(1) an unsaturated fluorinated olefin selected from the group consisting of tetrafluoroethylene, difluoroethylene, and mixtures of these;
(2) a fluorovinyl ether selected from the group consisting of perfluoro(alkyl vinyl) ethers, perfluoro(alkoxy vinyl) ethers, fluoro(alkyl vinyl) ethers, fluoro(alkoxy vinyl) ethers, and mixtures of these; and
(3) one or more cure site fluorinated monomers;
B. 0.1 to 20 parts per hundred parts fluoroelastomer A of a metal sulfide of formula (I):
M-S (I),
M being selected from Zn, Mg, Ca, Mn, Fe, and Cu;
C. 0.1 to 10 parts per hundred parts fluoroelastomer A of a peroxide curing agent;
D. 0.5 to 100 parts per hundred parts fluoroelastomer A of carbon black;
E. 0.5 to 25 parts per hundred parts fluoroelastomer A of one or more fillers selected from the group consisting of nonperfluoro fluorine-containing elastomers, micropowders, anhydrous silica, acidic silica, and fumed silica; and
F. 0.01 to 10 parts per hundred parts fluoroelastomer A of at least one co-agent, to result in a cured compound,
wherein, when the compound has been cured:
the compression set of the cured compound, as measured in air at 168 hours according to method ASTM D395-89, ranges from between 4% and 20% greater than the compression set, as measured for the same duration and by the same method, of an identical cured compound lacking element B.

16. The process of claim 15, wherein the compound further comprises an additive selected from stabilizers, plasticizers, lubricants, and processing aids and the cure site fluorinated monomer comprises at least one bromine or at least one iodine atom.

17. The process of claim 15, wherein the compression set, as measured in air at 168 hours according to method ASTM D395-89, ranges between 4% and 15% greater than the compression set, as measured for the same duration and by the same method, of an identical cured compound lacking element B.

18. An article made by the process of claim 15.

19. The article of claim 18 in the form of a gasket, seal, tubing, diaphragm, or O-ring.
